(19) United States
(12) Patent Application Publication
(10) Pub. No.: US 2009/0031834 A1
(43) Pub. Date: Feb. 5, 2009

(54) Automated Transmission Control Apparatus, Power Unit Provided With Automatic Transmission Control Apparatus, and Straddle-Type Vehicle

(75) Inventor: Yoshihiko Takeuchi, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/178,503

(22) Filed: Jul. 23, 2008

(30) Foreign Application Priority Data
Jul. 24, 2007 (JP) 2007-191560

(51) Int. Cl. F16H 35/00

(52) U.S. Cl. 74/335

(57) ABSTRACT

An automatic transmission control apparatus that shortens the time from starting to finishing a shift motion and suppresses overload applied to a shift actuator. A transmission apparatus has a plurality of shift gear pairs with different transmission gear ratios, and a gear selecting mechanism that selects a shift gear pair transmitting power. A shift motor drives the gear selecting mechanism. A shift power transmission mechanism transmits power of the motor to the gear selecting mechanism. A mechanical fuse within the shift power transmission mechanism generates an irreversible state change such that the transmission power becomes equal to or less than a predetermined value if the transmission power exceeds the predetermined value.

### RELATED APPLICATIONS

This application claims the benefit of priority under 35 USC 119 of Japanese patent application no. 2007-191560, filed on Jul. 24, 2007, which application is hereby incorporated by reference in its entirety.

### BACKGROUND OF THE INVENTION

1. Field of the Invention

The present invention relates to an automatic transmission control apparatus that automatically changes a shift gear of a transmission apparatus.

2. Description of Related Art

A vehicle provided with an automatic transmission control apparatus for automatically changing a shift gear is known. Generally, the automatic transmission control apparatus is provided with a transmission apparatus having a plurality of shift gear pairs having different transmission gear ratios, a gear selecting mechanism selecting a shift gear pair transmitting power from among the plurality of shift gear pairs, a shift actuator driving the gear selecting mechanism, and a shift power transmission mechanism transmitting power of the shift actuator to the gear selecting mechanism.

In such a transmission apparatus having a dog gear, at the time of changing gears, the gear may not be smoothly engaged or disengaged. In a foot-operated type transmission apparatus driving the gear selecting mechanism by a shift pedal, for example, the gear is engaged and disengaged by repeatedly adjusting a pedaling operation, and the shifting motion is completed. However, to automatically carry out this motion by an automatic transmission control apparatus, an input by a shift actuator must be adjusted on the basis of a complicated control. On the other hand, if a condition that the gear is not smoothly engaged and disengaged is left, a rotation of a shift power transmission mechanism is brought under control in spite that the shift actuator is under an excited state. Accordingly, the shift actuator cannot be rotated, and the shift actuator may come to an overload state.

Japanese Patent No. 3044498 proposes an automatic transmission control apparatus in which a coil spring is provided between the shift actuator and a shift drum of the gear selecting mechanism. In Japanese Patent No. 3044498, when rotation of the shift power transmission mechanism is brought into control in spite that the shift actuator is under the excited state, the coil spring is elastically deformed and overload applied to the shift actuator is prevented.

However, in order to prevent the overload from being applied to the shift actuator, an elastic coefficient of the coil spring must be set smaller. In other words, a compression load (compression load of the coil spring) must be set at a time when the coil spring is elastically deformed weaker. Specifically, it must be set to allow motion of the shift actuator when the shift power transmission mechanism stops.

However, as the compression load of the coil spring becomes weaker, the difficulty by which the dog of the dog gear comes off increases. Accordingly, if the compression load of the coil spring is set weaker, the gears under the engaged state are not smoothly disconnected, so that there is a new problem that the time from starting to finishing the shift motion is increased.

On the other hand, if the compression load of the coil spring is set stronger, the overload applied to the shift actuator cannot be suppressed to a level that is originally expected. Accordingly, when the compression load of the coil spring is set stronger, the torque of the shift actuator must be independently suppressed in order to prevent overload from being applied to the shift actuator.

However, if the torque of the shift actuator is suppressed, rotating speed is reduced. Accordingly, even in this case, there is the problem that the time from starting to finishing the shift motion is increased.

### SUMMARY OF THE INVENTION

The present invention addresses these issues, and provides an automatic transmission control apparatus that shortens the time from starting to finishing the shift motion and suppresses the overload applied to the shift actuator.

The present invention provides an automatic transmission apparatus comprising a transmission apparatus having a plurality of shift gear pairs with different transmission gear ratios, and a gear selecting mechanism selecting a shift gear pair transmitting power from among the plurality of shift gear pairs. A shift actuator drives the gear selecting mechanism. A shift power transmission mechanism transmits power of the shift actuator to the gear selecting mechanism. A mechanical fuse deforms when the shift actuator comes to an overload state so as to shut off the transmission of power from the shift actuator to the gear selecting mechanism.

Deformation of the mechanical fuse indicates a deformation that does not restore to its original state after being once generated. Deformation includes, for example, a rupture.

The automatic transmission control apparatus is provided with a mechanical fuse that is deformed when the shift actuator comes to the overload state so as to shut off transmission of power from the shift actuator to the gear selecting mechanism. Accordingly, when the shift actuator comes to the overload state for some reason, power transmission from the shift actuator to the gear selecting mechanism is shut off. Therefore, overload of the shift actuator is suppressed. Further, the automatic transmission control apparatus neither suppresses the torque of the shift actuator itself for suppressing the overload applied to the shift actuator, nor employs a torque limiter constructed by an elastic member having a small elastic coefficient or the like. Accordingly, the time from starting to finishing the shift motion is shortened. Therefore, the present invention achieves both suppression of overload of the shift actuator and shortening of the time for the shift motion.

The present invention also provides a power unit comprising an engine; a casing storing the engine; and an automatic transmission control apparatus as described above. The shift power transmission mechanism has a first transmission mechanism portion positioned within the casing and a second transmission mechanism portion positioned out of the casing that is detachable with respect to the first transmission mechanism portion. The mechanical fuse is provided within the second transmission mechanism portion.

In the power unit mentioned above, the mechanical fuse is provided within the second transmission mechanism portion arranged outside of the casing. Further, the second transmission mechanism portion is detachable with respect to the first transmission mechanism portion arranged within the casing. Accordingly, when the mechanical fuse works, the second transmission mechanism portion including the mechanical fuse can be easily replaced without disassembling the casing. Therefore, when the mechanical fuse works, a state in which shift motion can be carried out can be immediately restored by replacing the shift rod, and the effects of suppressing overload applied to the shift actuator and shortening the time from starting to finishing the shift motion are maintained.

The present invention also provides a straddle-type vehicle comprising the power unit.

Since the straddle-type vehicle is provided with a power unit having the mechanical fuse, the time from starting to finishing the shift motion is shortened and overload applied to the shift actuator is suppressed.

The present invention provides an automatic transmission control apparatus that shortens the time from starting to finishing the shift motion and suppresses the overload applied to the shift actuator, a power unit provided with the automatic transmission control apparatus, and a straddle-type vehicle.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a side view of a motorcycle according to the present invention.

FIG. 2 is a side view showing a layout of an actuator of an automatic transmission control apparatus according to the present invention.

FIG. 3 is a cross sectional view of a power unit according to the present invention.

FIG. 4 is an exploded cross sectional view of a shift motor and a shift power transmission mechanism according to the present invention.

FIG. 5 is a side view of a clutch operation unit according to the present invention.

FIG. 6 is a side view of the clutch operation unit.

FIG. 7 is an enlarged view of a shift rod of the mechanism of FIG. 4.

FIG. 8 is an enlarged side view of a portion near the shift rod.

FIG. 9 is an enlarged view of a portion near the power transmission portion of FIG. 7.

FIG. 10 is a system view of an automatic transmission control mechanism according to the present invention.

FIG. 11 is a perspective view of a switch portion of a handle grip according to the present invention.

FIG. 12(a) is an enlarged cross sectional view of a portion near the power transmission portion before being deformed; and FIG. 12(b) is an enlarged cross sectional view of the portion near the power transmission portion after being deformed.

FIG. 13 is a side view of a portion near a third shaft, a power transmission portion and an operation lever in accordance with a first modified embodiment of the present invention.

FIG. 14 is an exploded perspective view of the third shaft, the power transmission portion and the operation lever of FIG. 13.

FIG. 15 is a cross sectional view of a power unit in accordance with a second modified embodiment of the present invention.

FIG. 16 is an exploded perspective view of a third shaft, a power transmission portion, a coupling member and a shift operation shaft in accordance with the second modified embodiment.

### DETAILED DESCRIPTION OF THE INVENTION

The inventor has found a tendency that overload applied to a shift actuator tends to occur in a specific state. One such specific state, for example, is that a gear is not smoothly engaged or disengaged when changing a gear pair transmitting power. Specifically, for example, the specific state includes a time when the dog of one gear is hard to come off from a hole portion of the other gear in the combination to be disengaged, and suddenly comes off at one point, and the dog of one gear of the combination to be newly engaged is not accurately fitted to the hole portion of the other gear, so that the dog of one gear comes into collision with a side surface of the other gear, in the case of changing the combination of the gears to be engaged.

Further, the inventor has found that overload tends to be applied to the shift actuator in the specific state mentioned above, and that a generation frequency of this specific state is low. As a result, the probability at which overload is generated in the shift actuator is low.

Accordingly, the inventor has conceived the present invention in which an automatic transmission control apparatus is provided with a mechanical fuse shutting off transmission of power from a shift actuator to a gear selecting mechanism, by deforming when overload is generated in the shift actuator. Further, the inventor has conceived that the mechanical fuse is provided in a detachable shift power transmission mechanism. Further, the inventor has conceived that the mechanical fuse is provided outside of the casing storing the engine.

An embodiment of the present invention is now described with reference to the drawings. While a straddle-type vehicle is described as an embodiment of the invention, the invention is not so limited and is applicable to other types of vehicles. Moreover, while a motorcycle is described as one example of a straddle-type vehicle, the invention is applicable to other straddle-type vehicles such as a motor tricycle, a buggy vehicle or the like.

<<Whole Structure of Motorcycle 1>>

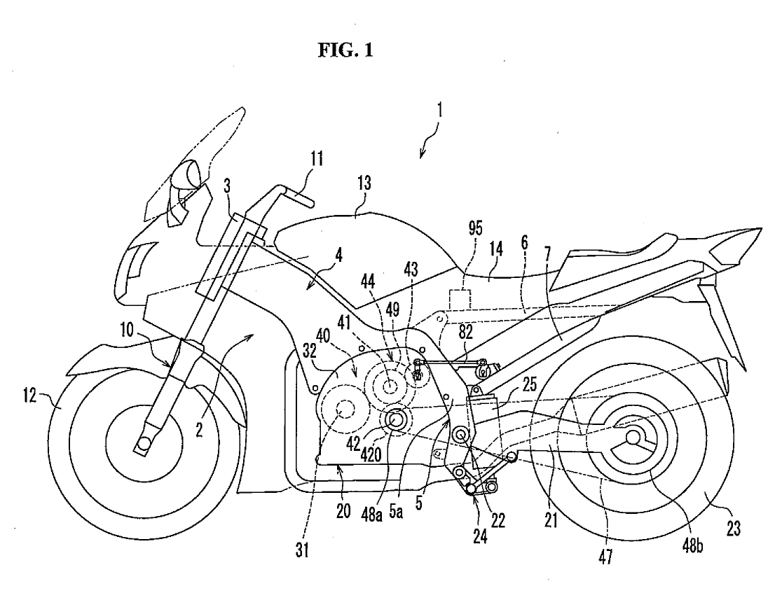

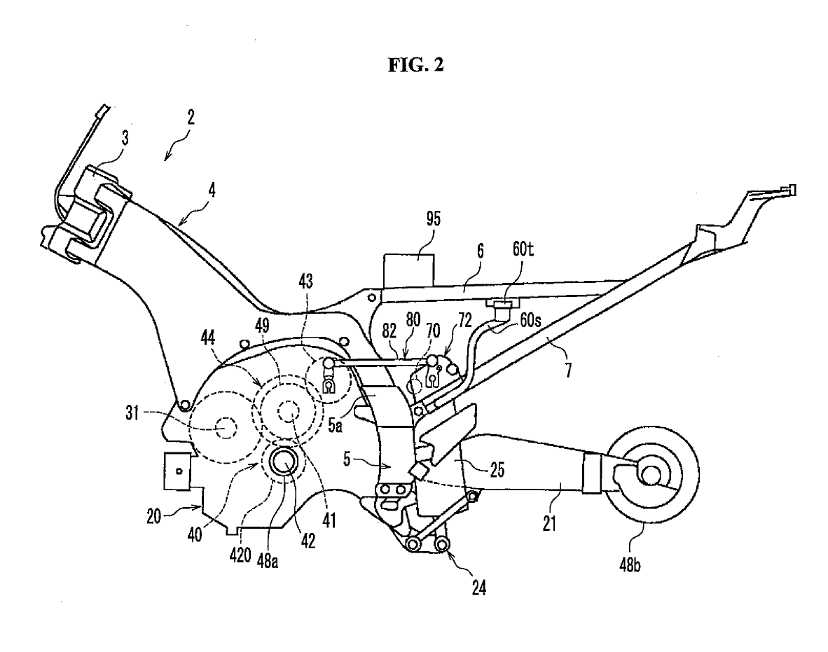

As shown in FIGS. 1 and 2, a motorcycle 1 in accordance with this embodiment is provided with a head pipe 3 and a vehicle body frame 2. Body frame 2 includes a main frame 4 extending backward from head pipe 3, and a rear arm bracket 5 extending downward from a rear portion of main frame 4. A back stay 7 is attached to an upper portion Sa of rear arm bracket 5. A rear portion of a seat rail 6 is coupled to a rear portion of back stay 7.

A front fork 10 is pivoted to head pipe 3. A steering handle 11 is provided in an upper end of front fork 10, and a front wheel 12 is provided in a lower end of front fork 10. A fuel tank 13 is arranged in an upper portion of main frame 4, and a seat 14 is arranged in a rear side of fuel tank 13. Seat 14 is mounted on seat rail 6.

A front end portion of a rear arm 21 is supported with rear arm bracket 5 so as to freely oscillate up and down via a pivot shaft 22. A rear wheel 23 is supported with a rear end portion of rear arm 21. Rear arm 21 is supported with body frame 2 via a link mechanism 24 and a rear cushion unit 25.

A power unit 20 having an engine serving as a driving source is suspended from main frame 4 and rear arm bracket 5. While a water-cooled four-cycle parallel four-cylinder type engine is depicted, the kind of engine is not limited. A cylinder axis of the engine is slightly inclined from a horizontal line toward a forward side of motorcycle 1. The engine is provided in a crank case 32 accommodating a crank shaft 31. Crank case 32 is suspended and supported from body frame 2 in both sides in a vehicle width direction.

A main shaft 41 is provided in parallel to crank shaft 31, Crank shaft 31 is coupled to main shaft 41 via a multiple disc clutch mechanism 44. Clutch mechanism 44 is described in detail later.

A multiple stage shift gear 49 is installed to main shaft 41. A drive shaft 42 is provided in parallel to main shaft 41, and shift gears 420 are installed to drive shaft 42 in correspondence to shift gears 49. Shift gears 49 on main shaft 41 are engaged with shift gears 420 on drive shaft 42. Any one or both of all shift gears 49 and 420 come to a free rotating (idle running) state with respect to main shaft 41 or drive shaft 42, except for one pair of selected shift gears. Accordingly, rotation transmission from main shaft 41 to drive shaft 42 is achieved by only one pair of selected shift gears.

Transmission apparatus 40 comprises main shaft 41, drive shaft 42, the plural stages of shift gears 49 and shift gears 420, and a gear selecting mechanism 43 selecting the shift gear pair transmitting power from among the plural stages of shift gears 49 and shift gears 420. Transmission apparatus 40 is integrally assembled in crank case 32.

As shown in FIG. 2, motorcycle 1 is provided with a shift motor 70 generating the power driving gear selecting mechanism 43 of transmission apparatus 40, and a shift power transmission mechanism 80 transmitting torque generated by shift motor 70 to gear selecting mechanism 43.

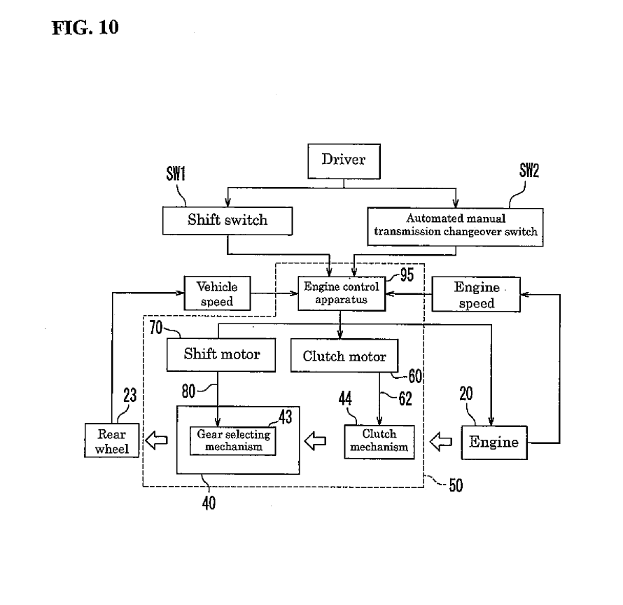

An automated manual transmission mechanism 50 (FIG. 10), also referred to as automatic transmission control apparatus 50, automatically actuates clutch mechanism 44 and switches the shift gear of transmission apparatus 40. Automatic transmission control apparatus 50 is described in detail later.

As shown in FIG. 1, a drive sprocket 48a is provided to drive shaft 42 and a driven sprocket 48b is provided to rear wheel 23. A chain 47 is wound around drive sprocket 48a and driven sprocket 48b. Accordingly, the power of the engine within power unit 20 transmitted to drive shaft 42 via transmission apparatus 40 is transmitted to rear wheel 23 via chain 47.

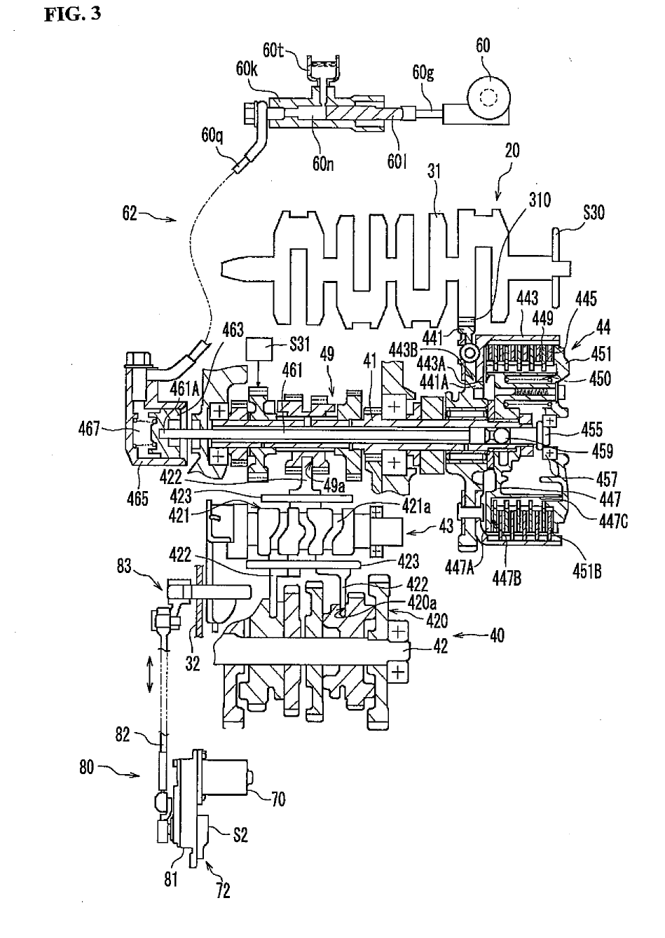

The whole structure of motorcycle 1 has been described above. Clutch mechanism 44 is now described in detail with reference to FIG. 3.

<<Structure of Clutch Mechanism 44>>

Clutch mechanism 44 comprises a multiple disc friction clutch including a tubular clutch housing 443, a tubular clutch boss 447, a plurality of friction discs 445 and clutch plates 449 serving as a friction plate, and a pressure plate 451. Clutch mechanism 44 includes a gear 441 engaging with a gear 310 formed in crank shaft 31. An engine speed sensor S30 is installed to an end portion of crank shaft 31. A main shaft rotating speed sensor S31 is provided in main shaft 41.

Clutch housing 443 has a tubular shape and is attached to main shaft 41 so as to be relatively rotatable. One end portion side (a left side in FIG. 3) of clutch housing 443 is provided with an engagement portion 443B in which an engagement hole 443A is formed. Engagement protruding portion 441A of gear 441 is fitted into engagement hole 443A, such that gear 441 and clutch housing 443 are engaged and relatively non-rotatable. A plurality of grooves extending in an axial direction of main shaft 41 is formed in an inner peripheral surface of a portion of clutch housing 443 formed in a tubular shape.

Each friction disc 445 is formed as a ring-shaped thin plate form. A plurality of teeth are formed in an outer periphery of each friction disc 445. Each friction disc 445 is attached to clutch housing 443 so as to be relatively non-rotatable, on the basis of engagement between the plurality of teeth formed in the outer periphery of friction disc 445 with the plurality of grooves formed in the inner peripheral surface of clutch housing 443. Friction discs 445 are attached to clutch housing 443 so as to be slidable in the axial direction of main shaft 41, and in such a manner that plate surfaces of friction discs 445 are approximately perpendicular to the axial direction of main shaft 41.

Clutch boss 447 is arranged in a more inner side in a diametrical direction of main shaft 41 than clutch housing 443, and is attached to main shaft 41 so as to be relatively non-rotatable. Clutch boss 447 is formed as a tubular shape. One end portion side (a left side in FIG. 3) of clutch boss 447 is provided with a circular flange portion 447A in which an outer diameter is approximately equal to an outer diameter of clutch plate 449. Clutch boss 447 is fixed to main shaft 41 in such a manner that a flange portion 447A is positioned in an engagement portion 443B side of clutch housing 443. A pressing portion 447B formed in a clutch plate 449 side of flange portion 447A pinches friction disc 445 and clutch plate 449 in the axial direction of main shaft 41, together with pressure plate 451. A plurality of grooves 447C extending in the axial direction of main shaft 41 are formed in an outer peripheral surface of a tubular portion of clutch boss 447.

Each clutch plate 449 is formed as a ring-shaped thin plate form. A plurality of teeth are formed in an inner peripheral surface of each clutch plate 449. Clutch plates 449 are attached to clutch boss 447 so as to be relatively non-rotatable on the basis of an engagement of the plurality of teeth formed in the inner periphery of clutch plate 449 with the plurality of grooves 447C formed in the outer peripheral surface of clutch boss 447. Clutch plates 449 are attached to clutch boss 447 so as to be slidable in the axial direction of main shaft 41, and in such a manner that plate surfaces of clutch plates 449 are approximately perpendicular to the axial direction of main shaft 41.

Friction discs 445 and clutch plates 449 are alternately arranged in the axial direction of the main shaft 41.

Pressure plate. 451 is relatively non-rotatable with clutch boss 447, and is slidable with respect to clutch boss 447 in the axial direction of main shaft 41. Pressure plate 451 is driven by a clutch motor 60. A flat pressing portion 451B formed in pressure plate 451 pinches friction disc 445 and clutch plate 449 in the axial direction of main shaft 41 together with pressing portion 447B of flange portion 447A.

Clutch mechanism 44 is provided with a plurality of springs 450 that surround tubular grooves 447C. Springs 450 bias pressure plate 451 toward a left side in FIG. 3. In other words, springs 450 bias pressure plate 451 in such a direction that pressing portion 451B of pressure plate 451 comes close to pressing portion 447B of clutch boss 447.

Pressure plate 451 is engaged with one end portion side (a right side in FIG. 3) of a push rod 455 via a bearing, for example, a deep groove ball bearing 457 or the like, in a center portion of pressure plate 451, and is rotatable with respect to push rod 455. The other end portion side (a left side in FIG. 3) of push rod 455 is engaged with an inner side of one end portion of tubular main shaft 41. An inner portion of tubular main shaft 41 is provided with a spherical ball 459 that is adjacent to the other (left) end portion of push rod 455, and a left side of ball 459 is provided with a push rod 461 that is adjacent to ball 459.

One (left) end portion 461A of push rod 461 protrudes from the other (left) end portion of tubular main shaft 41. A piston 463 connected to clutch motor 60 is integrally provided in the protruding one end portion 461A of push rod 461. Piston 463 is guided by a cylinder main body 465, and is slidable in the axial direction of main shaft 41.

The structure of clutch mechanism 44 has been described above. Gear selecting mechanism 43 and shift power transmission mechanism 80 are now described in detail.

<<Gear Selecting Mechanism 43>>

As shown in FIG. 3, gear selecting mechanism 43 is provided with a shift cam 421 corresponding to a shift input shaft, and a shift fork 422. A plurality of cam grooves 421a are formed in an outer peripheral surface of shift cam 421. Shift fork 422 has a shape bifurcating from a root portion to two leading end portions. The root portion of shift fork 422 is attached to a shift fork shaft 423 so as to be slidable in the axial direction. One leading end portion of shift fork 422 is engaged with cam groove 421a of shift cam 421. The other leading end portion of shift fork 422 is engaged with annular grooves 49a and 420a provided in shift gears 49 and 420.

In accordance with the structure mentioned above, if shift cam 421 is driven so as to be rotated, shift fork 422 is moved in the axial direction along cam groove 421a, and shift gears 49 and 420 are moved in the axial direction working therewith. Accordingly, only a pair of shift gears 49 and 420 at a position corresponding to a rotation angle of shift cam 421 come to a fixed state by a spline with respect to main shaft 41 and drive shaft 42. In accordance with this structure, the shift gear position is defined, and rotation is transmitted at a predetermined transmission gear ratio between main shaft 41 and drive shaft 42 via shift gear 49 and shift gear 420.

<<Shift Power Transmission Mechanism 80>>

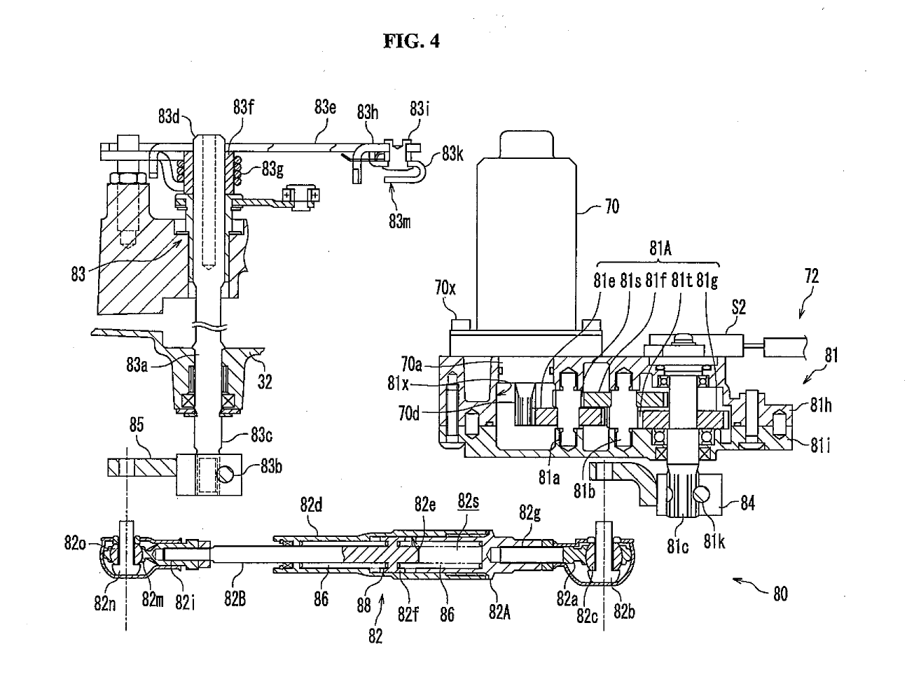

As shown in FIG. 4, shift power transmission mechanism 80 comprises a speed reducing mechanism 81 reducing a rotational speed of shift motor 70, a shift rod 82, and a shift link mechanism 83. An electric shift motor 70 is employed as the shift actuator in this embodiment of the invention however, the shift actuator may be alternatively constituted such as by a hydraulic actuator.

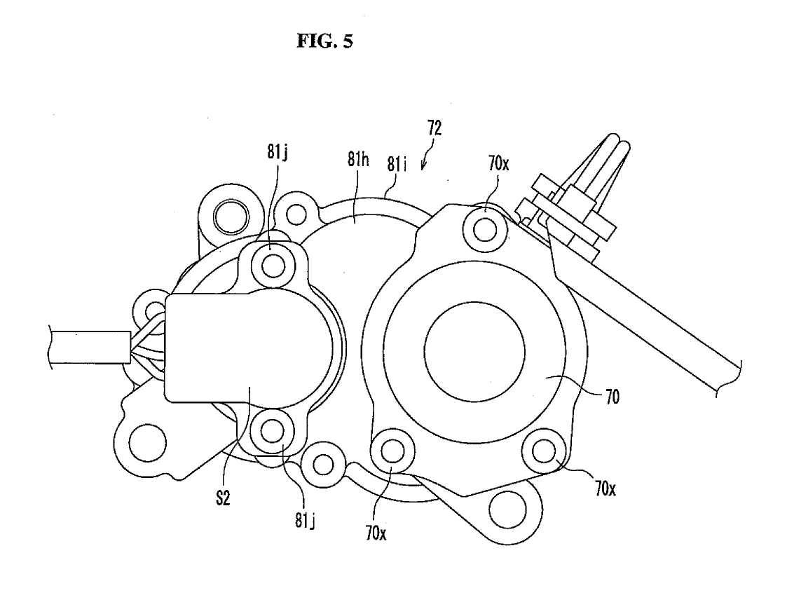

As shown in FIG. 5, shift motor 70 is integrated with a shift position detector S2 and speed reducing mechanism 81 as a shift actuator unit 72. As mentioned above, assembling work, maintenance, inspection and the like are made easier by integrating shift motor 70 and speed reducing mechanism 81 as shift actuator unit 72. As shown in FIG. 4, shift motor 70 and a gear case 81h of shift power transmission mechanism 80 are fixed by bolts 70x. An insertion hole 81x is provided in gear case 81h, and motor shaft 70a is inserted into gear cases 81h and 81i from insertion hole 81x, and is arranged within gear cases 81h and 81i. As mentioned above, shift power transmission mechanism 80 is structured such as to be detachable with respect to shift motor 70.

Speed reducing mechanism 81 is provided with four shafts 70a, 81a, 81b and 81c, and three speed reducing gears 81e, 81f and 81g. Speed reducing mechanism 81 is stored in gear cases 81h and 81i.

A first shaft of the four shafts is constituted by motor shaft 70a of shift motor 70. The second to fourth shafts are constituted by first shaft 81a, second shaft 81b and third shaft 81c. Motor shaft 70a (the first shaft) is an input shaft in speed reducing mechanism 81. A gear 70d is formed in a leading end portion of motor shaft 70a. Third shaft 81c (the fourth shaft) is a drive (output) shaft of speed reducing mechanism 81.

First speed reducing gear 81e is pressure inserted to first shaft 81a and is engaged with gear 70d of motor shaft 70a. A gear 81s is formed in first shaft 81a. Second speed reducing gear 81f is pressure inserted to second shaft 81b and is engaged with gear 81s of first shaft 81a. A gear 81t is formed in second shaft 81b. Third speed reducing gear 81g is pressure inserted to third shaft 81c and is engaged with gear 81t of second shaft 81b.

A speed reducing gear train 81A reducing the rotational speed of shift motor 70 is constituted by first speed reducing gear 81e, gear 81s, second speed reducing gear 81f, gear 81t and third speed reducing gear 81g. First speed reducing gear 81e existing in a most upstream side in speed reducing gear train 81A is engaged with gear 70d. In accordance with this structure, torque of shift motor 70 is transmitted to speed reducing gear train 81A via gear 70d, so as to be increased.

A shift position detector S2 is arranged in one end portion of third shaft 81c (the drive or output shaft) of speed reducing mechanism 81. Shift position detector (the angle sensor) S2 is arranged in an end portion of third shaft 81c, and is fastened and fixed to gear case 81h by attaching bolts 81j, as shown in FIG. 5.

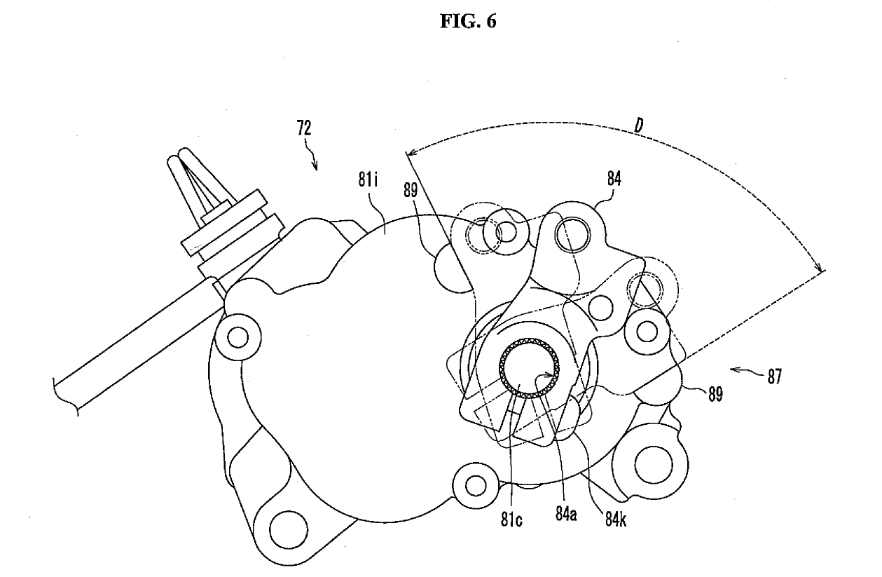

As shown in FIG. 4, an operation lever 84 is fixed to the other end portion of third shaft 81c. Specifically, as shown in FIG. 6, operation lever 84 is provided with an engagement hole 84a engaging with third shaft 81c, and a serration is formed in each of engagement hole 84a and third shaft 81c. Operation lever 84 is fixed to third shaft 81c by engaging the serrations between operation lever 84 and third shaft 81c, and fastening a bolt 81k. Operation lever 84 can not he relatively rotated with respect to third shaft 81c by being fixed in this manner. In accordance with this structure, if third shaft 81c corresponding to the drive (output) shaft of speed reducing mechanism 81 is rotated, operation lever 84 is oscillated.

Stopper members 89 and 89 regulating oscillation of operation lever 84 in a predetermined angle range D are attached to gear case 81i. Stopper members 89 and 89 form a stopper mechanism 87 together with operation lever 84. Stopper mechanism 87 regulates and prevents third shaft 81c from rotating to an angle position which deflects from a detection range of shift position detector (angle sensor) S2, by regulating the oscillating angle of operation lever 84 in predetermined range D.

As shown in FIG. 4, a shift motor side connection portion 82a of shift rod 82 is connected to operation lever 84 by a bolt 82b. Shift motor side connection portion 82a is supported so as to be rotatable with respect to bolt 82b by a bearing 82c. Accordingly, if operation lever 84 is oscillated, shift rod 82 is moved in a longitudinal direction.

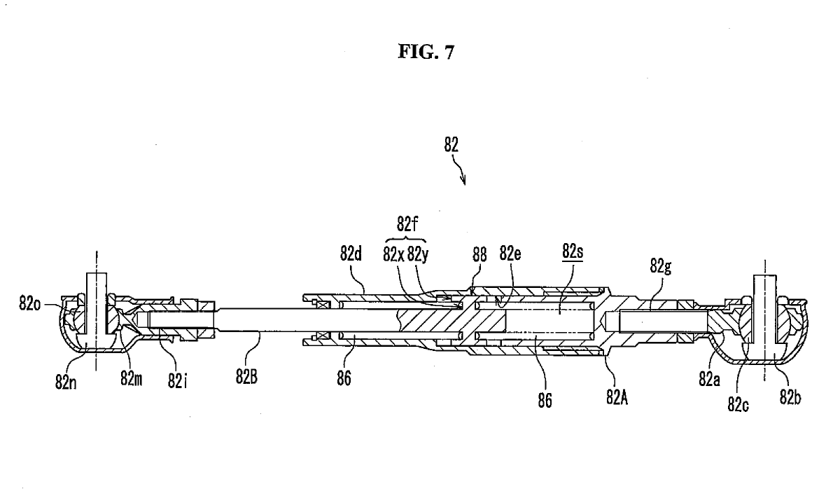

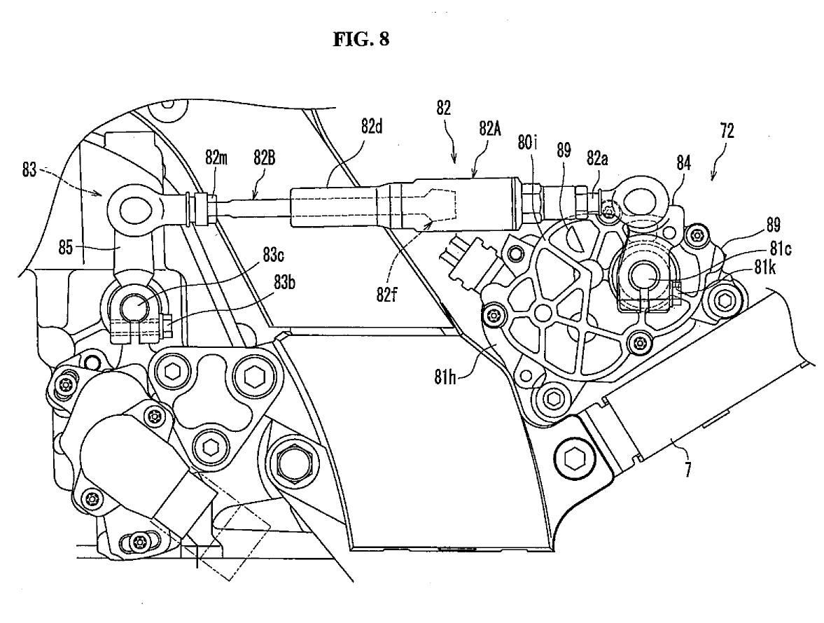

As shown in FIG. 7 or 8, shift rod 82 is provided with shift motor side connection portion 82a, a first rod structure portion 82A, a second rod structure portion 82B, and a shift link mechanism side connection portion 82m. A shift link mechanism 83 side of first rod structure portion 82A is formed by a tubular body 82d. An insertion hole 82s to which second rod structure portion 82B is inserted is formed in tubular body 82d. A concave portion 82e is formed in an inner wall surface 82t of tubular body 82d forming insertion hole 82s. A power transmission portion 82f protruding to an outer side in a peripheral direction from second rod structure portion 82B is formed in a shift motor side of second rod structure portion 82B.

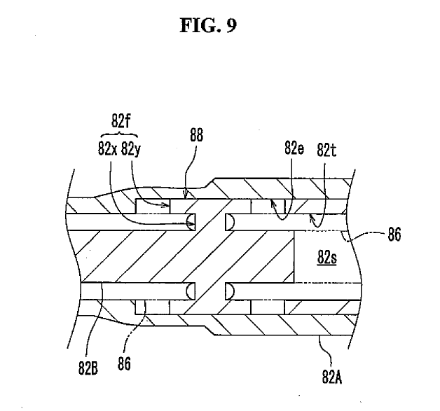

As shown in FIG. 9, power transmission portion 82f has a thin portion 82x and a thick portion 82y, and is formed such that a cross section at a time of cutting in a diametrical direction has approximately a T-shaped form. Second rod structure portion 82B is inserted to insertion hole 82s of tubular body 82d in such a manner that power transmission portion 82f is retained within concave portion 82e of first rod structure portion 82A. A coil spring 86 is provided in both sides in an axial direction of thin portion 82x of power transmission portion 82f within insertion hole 82s. Power transmission portion 82f is elastically supported by coil spring 86.

Power transmission portion 82f is engaged with concave portion 82e of first rod structure portion 82A so as to transmit the power from first rod structure portion 82A to second rod structure portion 82B. Thin portion 82x of power transmission portion 82f is formed in such a manner that if power transmitted by power transmission portion 82f becomes larger than a predetermined value T, thin portion 82x ruptures (deforms) so as to be separated from second rod structure portion 82B. Thus, in the present embodiment, power transmission portion 82f comprises a rupture portion that ruptures if the transmission power exceeds predetermined value T. In the present embodiment, power transmission portion 82f comprises a mechanical fuse 88.

As shown in FIGS. 4 and 7, an end portion (a right end in FIG. 4) close to shift motor 70 of first rod structure portion 82A is engaged with a thread portion 82g of shift motor side connection portion 82a. An end portion (a left end in FIG. 4) close to the shift link mechanism of second rod structure portion 82B is engaged with a thread portion 82i of shift link mechanism side connection portion 82m. Accordingly, a screwing amount of thread portion 82g or thread portion 82i is changed by rotating first rod structure portion 82A or second rod structure portion 82B, whereby it is possible to adjust a length of shift rod 82. As mentioned above, it is possible to easily adjust the length of shift rod 82 only by rotating first rod structure portion 82A or second rod structure portion 82B. Accordingly, a degree of freedom of the arranged position of shift motor 70 is enlarged. The structure for changing the length of shift rod 82 is not limited to the structure shown in FIGS. 4 and 7, and various other structures can be employed.

As shown in FIG. 4, shift link mechanism side connection portion 82m of second rod structure portion 82B is connected to operation lever 85 by a bolt 82n. Shift link mechanism side connection portion 82m is supported by a bearing 82o so as to be rotatable with respect to bolt 82n. Accordingly, if shift rod 82 is moved in the longitudinal direction, operation lever 85 is oscillated.

Operation lever 85 is fixed to shift operation shaft 83a of shift link mechanism 83. Specifically, operation lever 85 is provided with an engagement hole engaging with shift operation shaft 83a, and a serration is formed in each of the engagement hole and shift operation shaft 83a. Operation lever 85 is fixed to shift operation shaft 83a by engaging the serrations between operation lever 85 and shift operation shaft 83a, and fastening bolt 83b. Operation lever 85 cannot be relatively rotated with respect to shift operation shaft 83a by being fixed in this manner. In accordance with this structure, if operation lever 85 is oscillated, shift operation shaft 83a is rotated. As mentioned above, shift rod 82 is attached to shift link mechanism 83 via operation lever 85, and is detachable with respect to shift link mechanism 83.

Shift link mechanism 83 is arranged within crank case 32, and includes shift operation shaft 83a. Operation lever 85 is fixed to one end portion 83c of shift operation shaft 83a, and a link lever 83e is attached to the other end portion 83d of shift operation shaft 83a so as to be relatively non-rotatable. A holder 83f is attached to a side more inner than link lever 83e of the other end portion 83d of shift operation shaft 83a, and a coil spring 83g is wound around an outer peripheral surface of holder 83f. A support shaft 83i is attached to an end portion 83h of link lever 83e. A pawl piece 83k is rotatably attached to support shaft 83i. An engagement element 83m of the pawl piece 83k is engaged with a pin provided in an end portion of a shift cam 421 (see FIG. 3). Shift link mechanism 83, which is a part of shift power transmission mechanism 80, is detachable with respect to shift cam 421 of gear selecting mechanism 43. In accordance with this structure, if shift operation shaft 83a is rotated, link lever 83e is oscillated, and engagement element 83m of pawl piece 83k pushes the pin of shift cam 421 so as to rotationally drive shift cam 421. Coil spring 83g elastically holds pawl piece 83k at a neutral position.

In accordance with this structure, shift power transmission mechanism 80 is detachable with respect to gear selecting mechanism 43 and shift motor 70. Shift link mechanism 83 constructing shift power transmission mechanism 80 is arranged within crank case 32, and speed reducing mechanism 81 and shift rod 82 are arranged outside of crank case 32. Shift rod 82 and speed reducing mechanism 81, which are arranged outside of crank case 32, are detachable with respect to shift link mechanism 83 arranged within crank case 32. Power transmission portion 82f serving as mechanical fuse 88 is provided in shift rod 82 arranged outside of crank case 32, in shift power transmission mechanism 80.

The structures of gear selecting mechanism 43 and shift power transmission mechanism 80 have been described. Automatic transmission control apparatus 50 is now described.

<<Automatic Transmission Control Apparatus 50>>

As shown in FIG. 10, automatic transmission control apparatus 50 automatically actuates clutch mechanism 44 and switches the shift gear of transmission apparatus 40. Automatic transmission control apparatus 50 includes an engine control apparatus 95, a clutch motor 60 driving clutch mechanism 44, a clutch power transmission mechanism 62 (FIG. 3) transmitting the power of clutch motor 60 to clutch mechanism 44, a shift motor 70 driving gear selecting mechanism 43 Of transmission apparatus 40, a shift power transmission mechanism 80 transmitting a power of shift motor 70 to gear selecting mechanism 43, and other structure parts (various sensors and the like) necessary for automatic transmission control (an automated manual transmission).

<<System of Automatic Transmission Control Apparatus 50>>

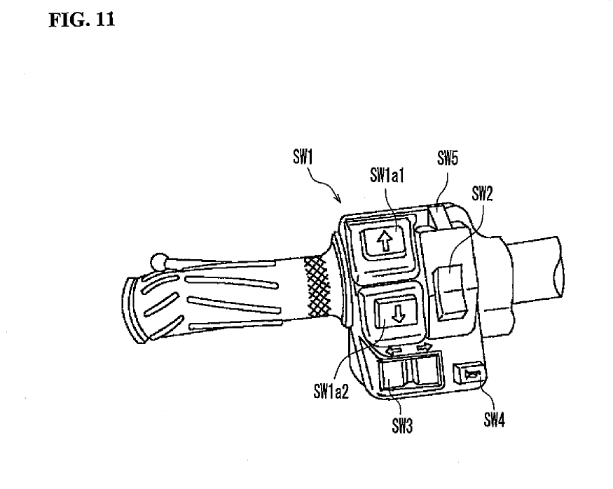

A system of automatic transmission control apparatus 50 is now described. As shown in FIG. 11, a shift switch SW1 is provided in a left grip side of steering handle 11. Shift switch SW1 includes a shift up switch SW1a1 and a shift down switch SW1a2, and appropriately increases or decreases a shift position of the shift gear between a first speed and a highest speed (for example, a sixth speed) on the basis of a manual operation of a driver. The left grip side also has a changeover switch SW2, a winker switch SW3, a horn switch SW4, and a light switch SW5. Changeover switch SW2 switches a gear shift motion to a semi-auto mode or a full-auto mode.

A switching motion of gear selecting mechanism 43 and clutch mechanism 44 by automatic transmission control apparatus 50 is now described. As shown in FIG. 10, gear selecting mechanism 43 and clutch mechanism 44 are both switched by automatic transmission control apparatus 50. In addition to shift position detector S2 of shift motor 70, motorcycle 1 has various sensors such as a clutch position detector of clutch motor 60, a vehicle speed sensor and the like.

When shift switch SW1 is operated by the driver, the switching of gear selecting mechanism 43 and clutch mechanism 44 is started. Engine control apparatus 95 drives clutch motor 60 and shift motor 70 on the basis of detection data of the various sensors and a command of shift switch SW1. Specifically, engine control apparatus 95 automatically carries out a series of shift motions such as a disconnection of clutch mechanism 44, a switching of the shift gear of transmission apparatus 40, and a connection of clutch mechanism 44, on the basis of a predetermined program previously stored within engine control apparatus 95 and the other computing circuits. The series of shift motions is described in detail below.

<<Disconnecting Motion of Clutch Mechanism 44>>

The disconnecting motion of clutch mechanism 44 is first described. First, engine control apparatus 95 rotationally drives clutch motor 60 on the basis of the command of shift switch SW1. An output shaft 60g is moved in a leftward direction in FIG. 3. Accordingly, a piston 60l of a cylinder 60k is pushed in a leftward direction in FIG. 3, and oil existing within an oil chamber 60n is fed through an oil hose 60q to a space 467 surrounded by a cylinder main body 465 and a piston 463. If oil is fed to space 467, piston 463 is moved in a rightward direction in FIG. 3. A reservoir tank 60t is communicated with oil chamber 60n via a reservoir hose 60s (see FIG. 2).

A pressure plate 451 is pushed in the rightward direction in FIG. 3 via a push rod 461, a ball 459, a push rod 455 and a deep groove ball bearing 457, on the basis of movement in the rightward direction of piston 463. If the force at a time of being pushed is larger than a force which spring 450 biases pressure plate 451 in the leftward direction in FIG. 3, pressure plate 451 is moved in the rightward direction in FIG. 3. Further, a pressing portion 451B of pressure plate 451 is disconnected from a friction disc 445. Accordingly, a pressure connection between friction discs 445 and clutch plates 449 is canceled, and a friction force capable of transmitting torque is not generated between friction discs 445 and clutch plates 449. Clutch mechanism 44 is disconnected in this manner to be in a non-connected state.

As mentioned above, if clutch mechanism 44 is disconnected, the switching motion of the shift gear of transmission apparatus 40 is carried out next. The switching motion of the shift gear is now described.

<<Switching Motion of Shift Gear>>

If clutch mechanism 44 is disconnected, engine control apparatus 95 rotationally drives shift motor 70 while keeping the non-connected state of clutch mechanism 44. Accordingly, gear 70d of motor shaft 70a is rotated. As shown in FIG. 4, first speed reducing gear 81e, first shaft 81a, gear 81s, second speed reducing gear 81f, second shaft 81b, gear 81t and third speed reducing gear 81g are rotated alphabetically in an interlocking manner, on the basis of rotation of gear 70d. Therefore, third shaft 81c corresponding to the drive (output) shaft of speed reducing mechanism 81 is rotated.

As shown in FIG. 4, shift position detector S2 is attached to an end portion of third shaft 81c. Shift position detector S2 determines position information on the basis of rotation of third shaft 81c, and transmits the position information to engine control apparatus 95. Engine control apparatus 95 controls shift motor 70 on the basis of this position information.

If third shaft 81c is rotated, operation lever 84 is oscillated, and if operation lever 84 is oscillated, shift rod 82 is moved in the longitudinal direction. If shift rod 82 is moved, operation lever 85 is oscillated, and if operation lever 85 is oscillated, shift operation shaft 83a is rotated. If shift operation shaft 83a is rotated, link lever 83e is oscillated, and shift cam 421 is rotated at a predetermined angle via engagement element 83m of pawl piece 83k.

As shown in FIG. 3, if shift cam 421 is rotated, shift fork 422 is moved in the axial direction a predetermined amount in accordance with cam groove 421a. On the basis of this motion of shift fork 422, a pair of shift gears 49 and 420 are alphabetically fixed to main shaft 41 and drive shaft 42. On the basis of this motion, the predetermined shift gear pair transmitting the power is selected, and switched. Accordingly, the rotational driving force transmitted to main shaft 41 is transmitted to drive shaft 42 at a predetermined speed reducing ratio.

Meanwhile, there is a case that transmission apparatus 40 is not actuated because shift gears 49 and 420 are not smoothly engaged and disengaged, and shift power transmission mechanism 80 cannot transmit torque to transmission apparatus 40 even though shift motor 70 operates. In this case, excessive torque is generated in shift power transmission mechanism 80, and shift motor 70 comes to an overload state.

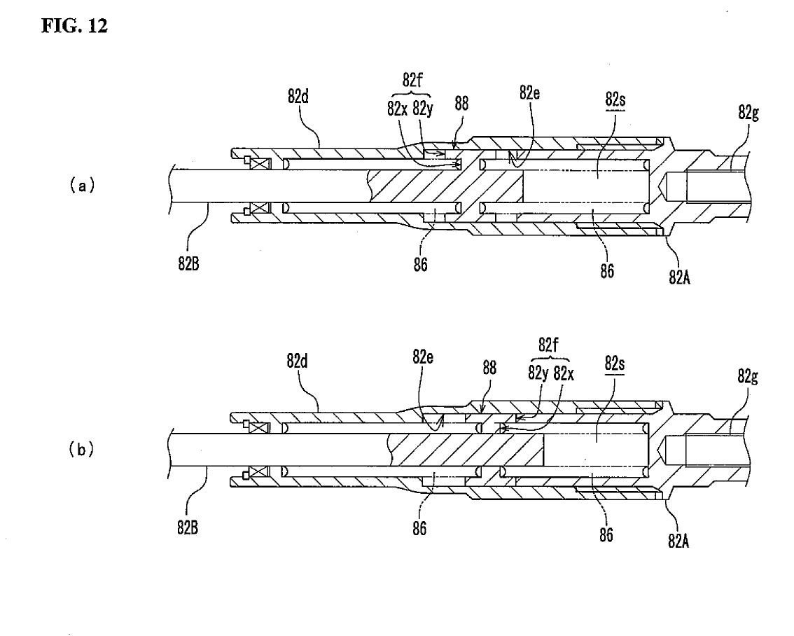

However, automatic transmission control apparatus 50 is provided with power transmission portion 82f serving as mechanical fuse 88. Accordingly, shift motor 70 can be inhibited from coming to the overload state. Specifically, as shown in FIGS. 12(a) and 12(b), if the power transmitted by power transmission portion 82f of shift power transmission mechanism 80 exceeds predetermined value T, thin portion 82x of power transmission portion 82f ruptures, and power transmission portion 82f is disconnected from second rod structure portion 82B (FIG. 12(b)). Accordingly, the power applied to shift power transmission mechanism 80 is reduced, and the load applied to shift motor 70 is suppressed.

Predetermined value T means a magnitude of transmission power that is set to prevent overload of shift motor 70. In this embodiment, predetermined value T is set to a limit value of power that shift power transmission mechanism 80 can transmit without overloading shift motor 70. Predetermined value T can be optionally set to a smaller value than this limit value.

As mentioned above, when transmission apparatus 40 is not actuated for some reason, the power transmitted by the shift power transmission mechanism 80 is limited to predetermined value T or less by mechanical fuse 88. Accordingly, the load of shift motor 70 can be limited, and shift motor 70 is inhibited from coming to the overload state. Further, since the force applied to shift gears 49 and 420 is limited to the predetermined force or less in accordance with this structure, the shift motion can be prevented from being stopped due to the excessive force applied to shift gears 49 and 420. Therefore, shift gears 49 and 420 are finally engaged and disengaged so as to be fixed to main shaft 41 and drive shaft 42, and the shift motion is finished.

Second rod structure portion 82B is inserted to insertion hole 82s of tubular body 82d in such a manner that power transmission portion 82f is retained within concave portion 82e of first rod structure portion 82A. Accordingly, when thin portion 82x of power transmission portion 82f ruptures, and power transmission portion 82f is disconnected from second rod structure portion 82B, disconnected power transmission portion 82f is accommodated within concave portion 82e of first rod structure portion 82A (FIG. 12(b)).

After the shift gear is switched in this manner, clutch mechanism 44 is changed from the non-connected state to the connected state. A connecting motion of clutch mechanism 44 is now described.

<<Connecting Motion of Clutch Mechanism 44>>

If the switching of the shift gear is finished, engine control apparatus 95 rotationally drives clutch motor 60 in the reverse direction. Output shaft 60g of clutch motor 60 is accordingly moved little by little in the rightward direction in FIG. 3, and piston 601 is moved in the rightward direction in FIG. 3 after the fashion of output shaft 60g. On the basis of the movement of piston 60l, a working fluid flows in oil chamber 60n from space 467 surrounded by cylinder main body 465 and piston 463 through oil hose 60q.

On the basis of the movement of the working fluid mentioned above, piston 463 biased by pressure plate 451 and spring 450 is moved little by little in the leftward direction in FIG. 3. Accordingly, pressure plate 451 is moved little by little in the leftward direction in FIG. 3. Pressing portion 451B of pressure plate 451 is finally brought into contact with friction disc 445, and presses friction disc 445 in the leftward direction in FIG. 3. Accordingly, friction discs 445 and clutch plates 449 are pinched by pressing portion 447B of clutch boss 447 and pressing portion 451B of pressure plate 451, and a friction force is generated between friction discs 445 and clutch plates 449. If pressure plate 451 is further moved in the leftward direction in FIG. 3, the friction force generated between friction disc 445 and clutch plate 449 becomes large on the basis of the biasing force of spring 450. As a result, a slip is hardly generated between friction disc 445 and clutch plate 449, and a friction force capable of transmitting torque from clutch housing 443 to clutch boss 447 is generated between friction disc 445 and clutch plate 449. In this manner, clutch mechanism 44 is connected and comes to a connected state.

As mentioned above, automatic transmission control apparatus 50 is provided with mechanical fuse 88 that generates an irreversible state change (rupture in the present embodiment) such that if the transmission power exceeds the predetermined value, the transmission power becomes the predetermined value or less. In other words, mechanical fuse 88 generates the irreversible state change (rupture) if shift motor 70 comes to the overload state, and shuts off transmission of power from shift motor 70 to gear selecting mechanism 43. Accordingly, since transmission of power from shift motor 70 to gear selecting mechanism 43 is shut off if shift motor 70 comes to the overload state for some reason, overload of shift motor 70 can be suppressed. Automatic transmission control apparatus 50, in accordance with the present embodiment, does not suppress overload applied to shift motor 70 either by suppressing the torque of the shift motor itself or by using a torque limiter constructed by an elastic member having a small elastic coefficient or the like. Accordingly, the time from starting to finishing the shift motion can be shortened. Therefore, on the basis of automatic transmission control apparatus 50 in accordance with the present embodiment, overload of shift motor 70 is suppressed and the time of the shift motion is shortened.

Mechanical fuse 88 functions only one time, and does not function plural times. Since mechanical fuse 88 reduces transmission power on the basis of an irreversible state change, mechanical fuse 88 cannot transmit power of shift motor 70 to gear selecting mechanism 43 once it has functioned, whereby shift motor 70 comes to a state in which shift motion cannot be carried out.

However, mechanical fuse 88 functions only in a special state in which overload is generated in shift motor 70. The frequency of this state is low. Further, in this embodiment, mechanical fuse 88 is provided in a detachable shift power transmission mechanism 80.

Therefore, in accordance with the present invention, mechanical fuse 88 can be easily replaced by replacing detachable shift power transmission mechanism 80. Accordingly, if mechanical fuse 88 functions and shift motion cannot be carried out, the state in which shift motion can be carried out can be immediately restored by replacing shift power transmission mechanism 80. Therefore, in accordance with the invention, the effects of suppressing overload applied to shift motor 70 and shortening the time from starting to finishing the shift motion can be maintained.

The rotating or sliding member such as the engine, clutch mechanism 44 or the like is stored within crank case 32, which is filled with oil for lubricating these members. Therefore, it is troublesome to replace the members within crank case 32.

However, in power unit 20, mechanical fuse 88 is provided within shift rod 82 arranged outside of crank case 32. Shift rod 82 is detachably mounted to shift link mechanism 83 arranged within crank case 32, via operation lever 85. Accordingly, when mechanical fuse 88 functions, shift rod 82 including mechanical fuse 88 can be easily replaced without disassembling crank case 32. Therefore, if mechanical fuse 88 functions, a state in which shift motion can be carried out can be immediately restored by replacing shift rod 82, and the effects of suppressing overload applied to shift motor 70 and shortening the time from starting to finishing the shift motion can be maintained.

In the present embodiment, power transmission portion 82f is fixed to second rod structure portion 82B of shift rod 82. Power transmission portion 82f is engaged with first rod structure portion 82A so as to transmit power from first rod structure portion 82A to second rod structure portion 82B. If the transmitted power becomes larger than predetermined value T, power transmission portion 82f generates the irreversible state change (ruptures) so as to be disconnected from second rod structure portion 82B.

The fixing means is attached so as to be relatively immovable with respect to the power transmitting direction (the longitudinal direction of shift rod 82 in the present embodiment). Accordingly, the power transmission portion may be independently formed and attached by welding or the like so as to be immovable in the power transmitting direction, or may be integrally formed.

On the basis of power transmission portion 82f, mechanical fuse 88 in accordance with the present invention can be structured simply. Further, in power unit 20, when mechanical fuse 88 functions, it is possible to repair such that shift power transmission mechanism 80 serves (transmits the power), at least by refixing power transmission portion 82f to second rod structure portion 82B or replacing second rod structure portion 82B. Therefore, the number of the parts that must be replaced due to the function of mechanical fuse 88 is restricted. Accordingly, the cost caused by the function of mechanical fuse 88 is restricted.

In power unit 20, power transmission portion 82f is retained within concave portion 82e of first rod structure portion 82A. Accordingly, if the power transmitted by power transmission portion 82f becomes larger than predetermined value T and power transmission portion 82f is separated from second rod structure portion 82B, power transmission portion 82f is accommodated within concave portion 82e of first rod structure portion 82A. Therefore, the separated power transmission portion 82f is prevented from being energetically disconnected from second rod structure portion 82B, and interfering with other members.

Further, in accordance with the present invention, since motorcycle 1 is provided with power unit 20 having mechanical fuse 88, a straddle-type vehicle is provided in which the time from starting to finishing the shift motion is shortened, and overload applied to shift motor 70 is suppressed.

### MODIFIED EMBODIMENT 1

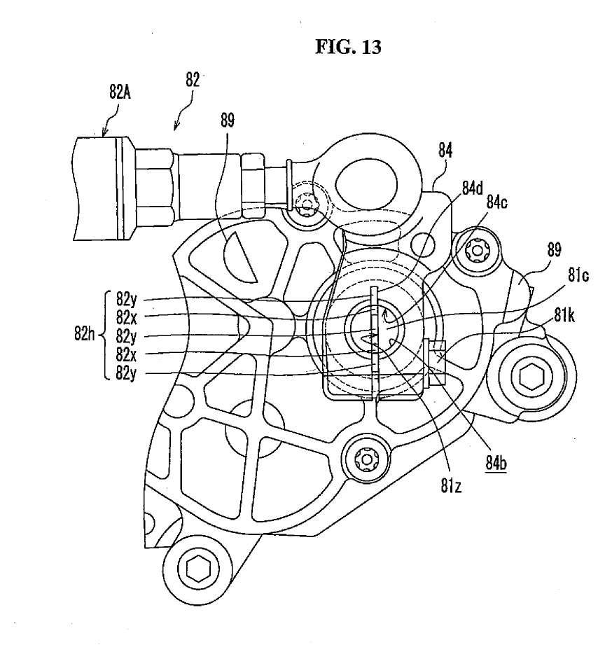

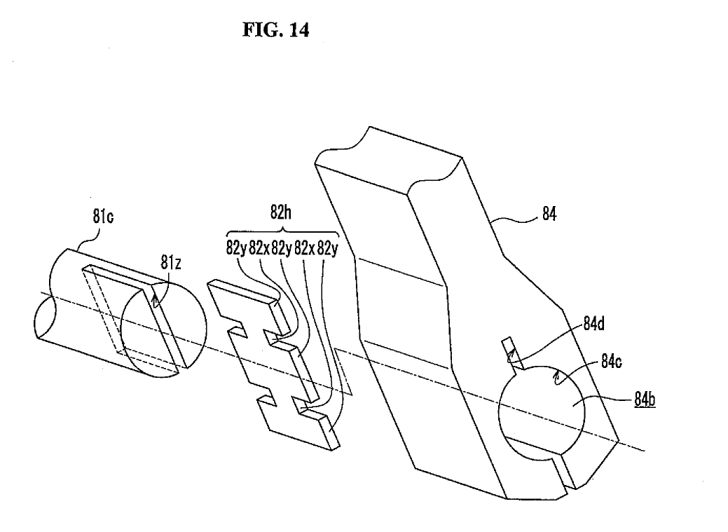

In the present embodiment, mechanical fuse 88 is constituted by power transmission portion 82f transmitting power from first rod structure portion 82A to second rod structure portion 82B. However, mechanical fuse 88 is not limited to this structure. For example, as shown in FIGS. 13 and 14, mechanical fuse 88 may be constituted by a power transmission portion 82h transmitting power from third shaft 81c constructing the drive (output) shaft of speed reducing mechanism 81 to operation lever 84.

Specifically, power transmission portion 82h is constituted by a plate-like body having two thin portions 82x formed between three thick portions 82y. Power transmission portion 82h is inserted to a notch portion 81z formed in the end portion of third shaft 81c. Accordingly, power transmission portion 82h is attached to third shift 81c so as to be relatively non-rotatable.

An insertion hole 84b to which third shaft 81c is inserted is formed in operation lever 84. A concave portion 84d is formed in an inner wall surface 84c of operation lever 84 forming insertion hole 84b. Third shaft 81c to which power transmission portion 82h is attached is inserted to insertion hole 84b of operation lever 84, bolt 81k is fastened, and operation lever 84 is fixed to third shaft 81c and power transmission portion 82h. At this time, third shaft 81c is inserted to insertion hole 84b in such a manner that thick portions 82y existing in both ends of power transmission portion 82h are retained to concave portion 84d. Accordingly, operation lever 84 becomes relatively non-rotatable with respect to third shaft 81c and power transmission portion 82h. In accordance with this structure, if third shaft 81c corresponding to the drive (output) shaft of speed reducing mechanism 81 is rotated, power from third shaft 81c is transmitted to operation lever 84 by power transmission portion 82h, and operation lever 84 is oscillated.

As shown in FIG. 13, power transmission portion 82h is formed such that two thin portions 82x are positioned in the end portions in the diametrical direction of third shaft 81c within notch portion 81z of third shaft 81c. Thin portion 82x of power transmission portion 82h is formed in such a manner as to rupture if the power (the rotating force in the modified embodiment 1) transmitted by power transmission portion 82h becomes larger than predetermined value T, and two thick portions 82y existing in a side more outer in the diametrical direction than thin portion 82x are formed in such a manner as to be disconnected from third shaft 81c.

As mentioned above, in the case that mechanical fuse 88 is constituted by power transmission portion 82h transmitting power from third shaft 81c constructing the drive (output) shaft of speed reducing mechanism 81 to operation lever 84, thin portion 82x of power transmission portion 82h ruptures (deforms) if shift motor 70 comes to overload, whereby transmission of power is shut off. Accordingly, since transmission of power is shut off when shift motor 70 comes to the overload state for some reason, overload of shift motor 70 is suppressed. When mechanical fuse 88 is structured as described above, the torque of the shift motor itself is not suppressed for suppressing overload applied to shift motor 70, and a torque limiter constituted by an elastic member having a small elastic coefficient or the like is not used. Accordingly, the time from starting to finishing the shift motion is shortened. Therefore, in accordance with modified embodiment 1, both suppression of overload of shift motor 70 and shortening of the time of the shift motion are achieved.

Mechanical fuse 88 in accordance with the present invention can be simply structured by power transmission portion 82h of modified embodiment 1. In accordance with power unit 20 of modified embodiment 1, when mechanical fuse 88 functions, it is possible to repair in such a manner that shift power transmission mechanism 80 functions (transmits power), at least by refixing power transmission portion 82h to notch portion 81z of third shaft 81c or replacing third shaft 81c. Therefore, the number of the parts that must be replaced after mechanical fuse 88 functions is reduced, and the cost caused by the function of mechanical fuse 88 is suppressed.

Further, in modified embodiment 1, power transmission portion 82h is retained within concave portion 84d of operation lever 84. Accordingly, if power transmitted by power transmission portion 82h becomes larger than predetermined value T and two thick portions 82y of power transmission portion 82h are detached from third shaft 81c, two thick portions 82y of power transmission portion 82h are accommodated within concave portion 84d of operation lever 84. Therefore, interference with other members by two detached thick portions 82y of power transmission portion 82h can be prevented.

### MODIFIED EMBODIMENT 2

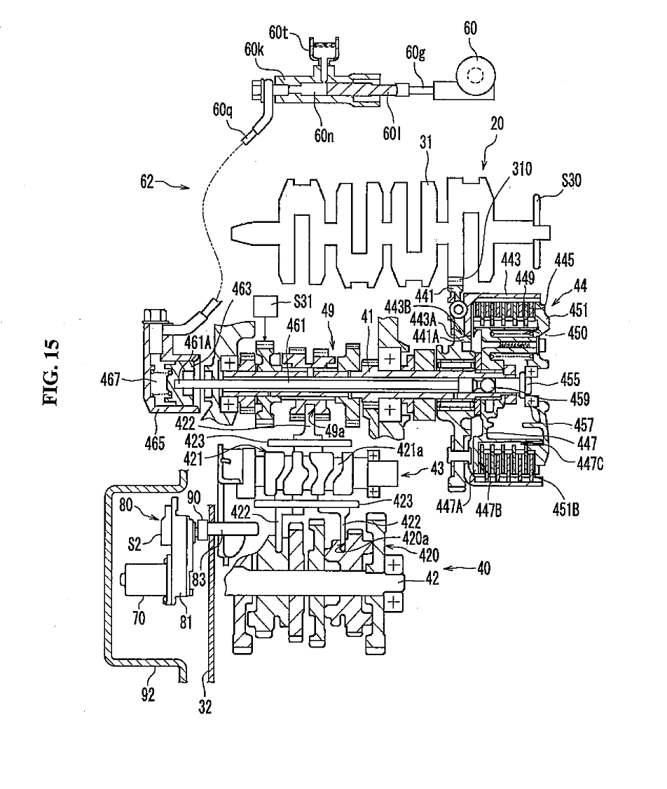

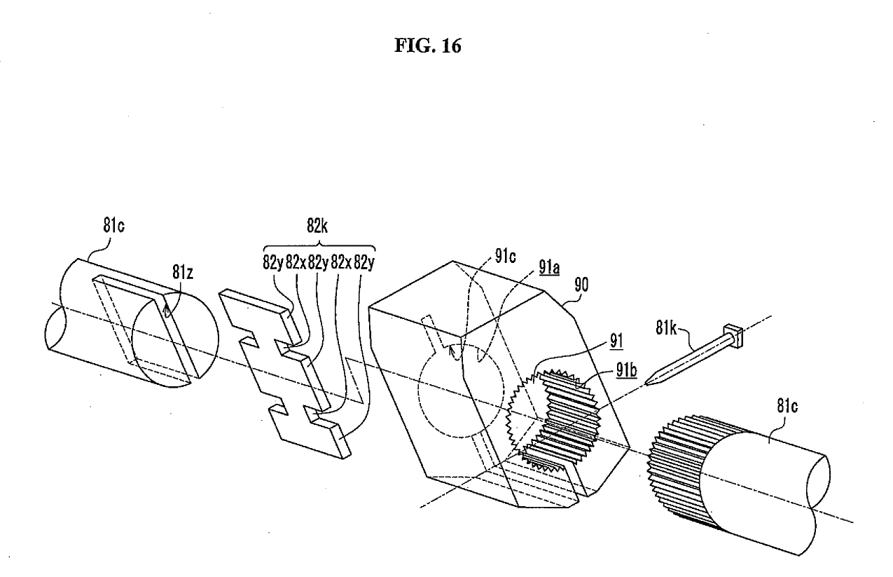

As shown in FIG. 3, shift power transmission mechanism 80 is provided with speed reducing mechanism 81 reducing the rotational speed of shift motor 70, operation lever 84, shift rod 82, operation lever 85, and shift link mechanism 83. However, shift power transmission mechanism 80 is not limited to this structure. As shown in FIG. 15, shift power transmission mechanism 80 may be constituted by speed reducing mechanism 81, shift link mechanism 83, and a coupling member 90 connecting speed reducing mechanism 81 and shift link mechanism 83. Coupling member 90 may be structured, for example, as shown in FIG. 16, by an element which coaxially couples third shaft 81c of speed reducing mechanism 81 and shift operation shaft 83a of shift link mechanism 83 so as to be relatively non-rotatable.

As shown in FIG. 16, an engagement hole 91 extending from one side toward the other side is formed in coupling member 90 in accordance with modified embodiment 2. Engagement hole 91 is formed by a hole 91a in one side and a hole 91b in the other side which have different shapes. Hole 91a is formed in the same shape as insertion hole 84b formed in operation lever 84 in modified embodiment 1. A concave portion 91d is provided in an inner wall surface 91c forming hole 91a. Hole 91b is formed in the same shape as engagement hole 84a of operation lever 84 in accordance with the embodiment mentioned above, and a serration is formed in hole 91b.

In modified embodiment 2, mechanical fuse 88 is structured by a power transmission portion 82k which is the same as power transmission portion 82h in accordance with modified embodiment 1. Power transmission portion 82k transmits power from third shaft 81c constructing the drive (output) shaft of speed reducing mechanism 81 to coupling member 90.

Specifically, power transmission portion 82k is constituted by a plate-shaped body having three thick portions 82y and two thin portions 82x formed between thick portions 82y, in the same manner as power transmission portion 82h in accordance with modified embodiment 1. Power transmission portion 82k is inserted to notch portion 81z formed in the end portion of third shaft 81c. Accordingly, power transmission portion 82k is attached to third shaft 81c so as to be relatively non-rotatable.

Third shaft 81c to which power transmission portion 82k is attached is inserted to hole 91a in one side of coupling member 90. At this time, third shaft 81c is inserted to insertion hole 84b in such a manner that thick portions 82y existing in both ends of power transmission portion 82k are retained to concave portion 91d. Shift operation shaft 83a of shift link mechanism 83 is inserted to hole 91b in the other side of coupling member 90 in such a manner that the serrations are engaged with each other. Third shaft 81c and power transmission portion 82k, and shift operation shaft 83a are fixed to coupling member 90 so as to be relatively non-rotatable, by fastening bolt 81k. In accordance with this structure, if third shaft 81c corresponding to the drive (output) shaft of speed reducing mechanism 81 is rotated, power from third shaft 81c is transmitted to coupling member 90 by power transmission portion 82k, and coupling member 90 is rotated. Shift operation shaft 83a is rotated in accordance with rotation of coupling member 90.

In this structure, in the same manner as modified embodiment 1, since thin portion 82x of power transmission portion 82k ruptures (deforms) if shift motor 70 comes to overload, transmission of power by shift power transmission mechanism 80 is shut off. Accordingly, if shift motor 70 comes to the overload state for some reason, transmission of power by shift power transmission mechanism 80 is shut off. Therefore, overload of shift motor 70 is suppressed. Further, since the torque of the shift motor itself is not restricted in order to suppress overload applied to shift motor 70, and a torque limiter constructed by an elastic member having a small elastic coefficient or the like is not used, the time from starting to finishing the shift motion can be shortened. Therefore, in accordance with modified embodiment 2, overload of shift motor 70 is suppressed and the time of the shift motion is shortened.

Further, in modified embodiment 2, as shown in FIG. 15, shift motor 70, speed reducing mechanism 81 and coupling member 90 are covered by a cover 92. Speed reducing mechanism 81 constructs a part of shift power transmission mechanism 80. Mechanical fuse 88 (power transmission portion 82k) is fixed to coupling member 90. However, shift motor 70, speed reducing mechanism 81 constructing a part of shift power transmission mechanism 80 and coupling member 90 are arranged outside of crank case 32. Further, speed reducing mechanism 81 and coupling member 90 are detachable with respect to shift link mechanism 83 arranged within crank case 32.

In modified embodiment 2, if mechanical fuse 88 functions, the shift motion can not be carried out. Accordingly, power transmission portion 82k must be replaced, and coupling member 90 and third shaft 81c must be detached at the time of replacing. Meanwhile, coupling member 90 and third shaft 81c are covered by cover 92. However, coupling member 90 and third shaft 81c are arranged outside of crank case 32. Accordingly, since coupling member 90 and third shaft 81c are not within crank case 32 filled with oil, it is possible to replace only by detaching cover 92 and without disassembling crank case 32. Therefore, in modified embodiment 2, when mechanical fuse 88 functions, power transmission portion 82k corresponding to mechanical fuse 88 can be easily replaced without disassembling crank case 32 filled with oil. Accordingly, in modified embodiment 2, a state in which shift motion can be carried out can be immediately restored after mechanical fuse 88 functions. Therefore, the effects of suppressing the overload applied to shift motor 70 and shortening the time from starting to finishing the shift motion are maintained.

Examples have been described in which shift power transmission mechanism 80 is provided with mechanical fuse 88 that ruptures if the transmission power exceeds predetermined value T. However, mechanical fuse 88 is not limited to this structure. For example, shift power transmission mechanism 80 may have a mechanical fuse 88 with a plastic deforming portion that is plastically deformed if the transmission power exceeds predetermined value T.

In the case mentioned above, if shift motor 70 comes to the overload state for some reason, transmission of power from shift motor 70 to gear selecting mechanism 43 is reduced by plastic deformation of the plastic deforming portion. Accordingly, overload of shift motor 70 can be suppressed. Further, since the torque of the shift motor itself is not suppressed in order to suppress the overload applied to shift motor 70, and a torque limiter constructed by an elastic member having a small elastic coefficient or the like is not used, in the same manner as described above, the time from starting to finishing the shift motion can be shortened. Therefore, in automatic transmission control apparatus 50 having a mechanical fuse 88 with a plastic deforming portion, both suppression of overload of shift motor 70 and shortening of the time of the shift motion are achieved.

Further, mechanical fuse 88 may be structured with an input member to which transmission power is input, and an output member that is engaged with and outputs power from the input member. Specifically, when the transmission power is equal to or less than predetermined value T, the input and output members are in an engaged state, and power is transmitted from the input to the output member. When the transmission power exceeds predetermined value T, the engagement between the input and output members is canceled, and transmission of power from the input to the output member is shut off.

In this case, if shift motor 70 comes to the overload state for some reason, transmission of power from shift motor 70 to gear selecting mechanism 43 is shut off on the basis of the cancellation of the engagement between the input and the output members of mechanical fuse 88. Therefore, overload of shift motor 70 is suppressed. Further, since overload of shift motor 70 is suppressed neither by suppression of the torque of the shift motor itself nor by using a torque limiter constructed by an elastic member having a small elastic coefficient or the like, in the same manner as described above, the time from starting to finishing the shift motion is shortened. Accordingly, both suppression of overload of shift motor 70 and shortening of the time of the shift motion are achieved.

<<Definition of Term>>

The term “irreversible state change” includes plastic deformation and the like in addition to rupture. Further, an “irreversible state change” may be a state change in which engagement between engaged members is canceled.

As mentioned above, the present invention is useful for an automatic transmission control apparatus that automatically carries out a shift gear change of a transmission apparatus, a power unit provided with the automatic transmission control apparatus, and a straddle-type vehicle provided with the automatic transmission control apparatus.

While particular embodiments of the invention have been described, it should be understood that these embodiments are exemplary, and not restrictive. Various modifications will be apparent to those of skill in the art and are within the scope of the present invention as set forth in the following claims.

1. An automatic transmission control apparatus comprising:
a transmission apparatus having a plurality of shift gear pairs with different transmission gear ratios, and a gear selecting mechanism selecting a shift gear pair transmitting power from among the plurality of shift gear pairs;
a shift actuator generating the power driving the gear selecting mechanism;
a shift power transmission mechanism transmitting the power of the shift actuator to the gear selecting mechanism; and
a mechanical fuse provided within the shift power transmission mechanism and generating an irreversible state change such that a transmission power becomes equal to or less than a predetermined value if the transmission power exceeds the predetermined value.

2. The automatic transmission control apparatus as claimed in claim 1, wherein at least a part of the shift power transmission mechanism including the mechanical fuse is detachable.

3. The automatic transmission control apparatus as claimed in claim 1, wherein the mechanical fuse is provided with a rupture portion that ruptures as the irreversible state change.

4. A power unit comprising:
the automatic transmission control apparatus as claimed in claim 1;
an engine; and
a casing storing at least the engine, wherein
the shift power transmission mechanism has at least a first transmission mechanism portion and a second transmission mechanism portion,
the first transmission mechanism portion is positioned within said casing,
the second transmission mechanism portion is positioned out of the casing and is detachable with respect to the first transmission mechanism portion, and
the mechanical fuse is provided within the second transmission mechanism portion.

5. The power unit as claimed in claim 4, wherein
the second transmission mechanism portion has a first member, and the second member closer to the gear selecting mechanism side than the first member,
the mechanical fuse is fixed to the second member between the first member and the second member, and has a power transmission portion engaging with the first member so as to transmit the power from the first member to the second member, and
the power transmission portion is detached from the second member if the transmitted power becomes larger than a predetermined value.

6. The power unit as claimed in claim 5, wherein
an insertion hole to which the second member is inserted is formed in the first member,
a concave portion is formed in an inner wall surface of the first member forming the insertion hole, and
the power transmission portion is retained in the concave portion.

7. The power unit as claimed in claim 4, wherein
the second transmission mechanism portion has a first member, and the second member is closer to the gear selecting mechanism side than the first member,
the mechanical fuse is fixed to the first member between the first member and the second member, and has a power transmission portion engaging with the second member so as to transmit the power from the first member to the second member, and
the power transmission portion is detached from the first member if the transmitted power becomes larger than a predetermined value.

8. The power unit as claimed in claim 7, wherein
an insertion hole to which the first member is inserted is formed in the second member,
a concave portion is formed in an inner wall surface of the second member forming the insertion hole, and
the power transmission portion is retained in the concave portion.

9. A straddle-type vehicle provided with the power unit as claimed in claim 4.

10. A straddle-type vehicle provided with the automatic transmission control apparatus as claimed in claim 1.
